(19) United States
(12) Patent Application Publication
(10) Pub. No.: US 2020/0183326 A1
(43) Pub. Date: Jun. 11, 2020

(54) AIR DUCT AND IMAGE FORMING APPARATUS

(71) Applicant: Konica Minolta, Inc., Tokyo (JP)

(72) Inventors: Kanehiro WATANABE, Sagamihara-shi (JP); Shinichi KAWABATA, Tokyo (JP)

(21) Appl. No.: 16/704,317

(22) Filed: Dec. 5, 2019

(30) Foreign Application Priority Data
Dec. 7, 2018 (JP) 2018-229500

(51) Int. Cl. G03G 21/20

(52) U.S. Cl. CPC G03G 21/206

(57) ABSTRACT

Provided is an air duct for guiding air containing scattered toner to a toner collector including a cyclone that centrifugally separates toner from the air containing scattered toner, and a filter that allows the air after the separation of the toner by the cyclone to pass through, the air duct including a first duct that guides the air downward and a second duct that is provided on the toner collector side relative to the first duct and is in communication with a side surface of the first duct, wherein a bottom surface of the first duct is provided on a lower side relative to a lower end of a communication opening for communication between the first duct and the second duct, thereby forming a reservoir that stores the toner.

### CROSS-REFERENCE TO RELATED APPLICATION

The present invention claims priority under 35 U.S.C. § 119 to Japanese Patent Application No. 2018-229500, filed on Dec. 7, 2018, the entire contents of which are incorporated herein by reference.

### BACKGROUND

### Technological Field

The present invention relates to an air duct and an image forming apparatus.

### Description of the Related Art

In electrophotographic image forming apparatuses, an electrostatic latent image formed on a surface of a photoconductor drum is visualized (developed) by toner, and the resulting toner image is transferred onto a sheet and is fixed by means of heating and pressing. In order to collect toner scattered around a developer, an air duct that draws in air around the developer is provided, and the air duct is connected to a toner collector. The toner collector includes a cyclone that centrifugally separates toner from air containing scattered toner and an electrostatic filter that allows the air after the separation of toner by the cyclone to pass through. Conventionally, when a predetermined number of runs is reached, a message urging replacement of the toner collector is provided on a display.

In order to increase the life of a filter and reduce the number of times of maintenance, for example, a development device including an exhaust outlet including first and second openings, in which a relationship in magnitude between a first exhaust air amount of exhaust air from the first opening and a second exhaust air amount of exhaust air from the second opening is changed according to clogging of a filter, has been proposed (see JP 2014-132322A).

However, since the predetermined number of runs set as a timing for replacement of the toner collector is set based on the time of occurrence of clogging of the electrostatic filter, it is difficult to enhance the CPP (cost per print). Since an electrostatic filter is expensive, a high frequency of replacement is a large burden to a user.

Also, in order to reduce the frequency of replacement of a filter, attempts to increase the efficiency of separation of toner by a cyclone have been made. In an attempt to enhance a flow rate of air in a cylinder of the cyclone, e.g., reduction of an inner diameter of the cyclone and downsizing of a suction port are conceivable; however, each of such attempts causes an increase in ventilation resistance, requiring enhancement in performance of a suction fan installed downstream of the filter and thus inevitably resulting an increase in cost.

### SUMMARY

The present invention has been made in view of the aforementioned problems in the conventional techniques, and an object of present invention is to reduce a frequency of replacement of a filter with no increase in cost.

To achieve at least one of the abovementioned objects, an air duct reflecting one aspect of the present invention is an air duct for guiding air containing scattered toner to a toner collector including a cyclone that centrifugally separates toner from the air containing scattered toner, and a filter that allows the air after the separation of the toner by the cyclone to pass through,

the air duct including a first duct that guides the air downward and a second duct that is provided on the toner collector side relative to the first duct and is in communication with a side surface of the first duct,

wherein a bottom surface of the first duct is provided on a lower side relative to a lower end of a communication opening for communication between the first duct and the second duct, thereby forming a reservoir that stores the toner.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram illustrating an overall configuration of an image forming apparatus according to a first embodiment of the present invention;

FIG. 2 is a block diagram illustrating a functional configuration of the image forming apparatus;

FIG. 3 is a diagram schematically illustrating a toner collector;

FIG. 4 is a sectional view schematically illustrating an area around a communication opening of an air duct;

FIG. 5 is a diagram for describing a connection configuration in the air duct;

FIG. 6 is a sectional view schematically illustrating an area around a communication opening of an air duct in a second embodiment;

FIG. 7 is a sectional view schematically illustrating an area around a communication opening of an air duct in a third embodiment;

FIG. 8 is a sectional view schematically illustrating an area around a communication opening of an air duct in a fourth embodiment;

FIG. 9A is a diagram for describing a configuration of a reservoir in an air duct in a fifth embodiment; and

FIG. 9B is a diagram of the air duct according to the fifth embodiment with the reservoir removed from a duct body.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

First, a first embodiment of the present invention will be described with reference to the drawings. However, the scope of the invention is not limited to the illustrated examples.

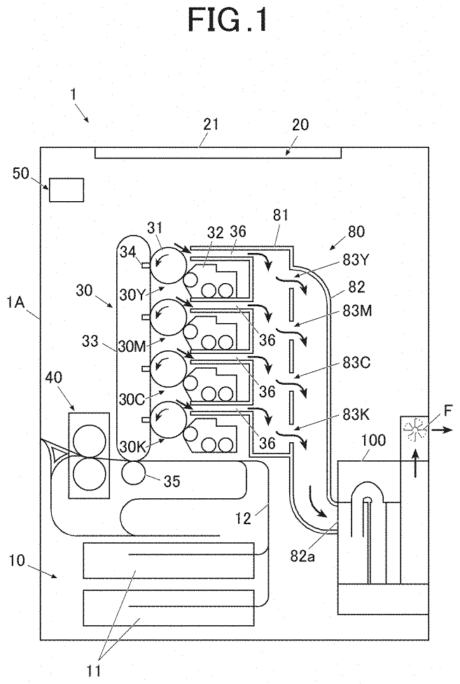

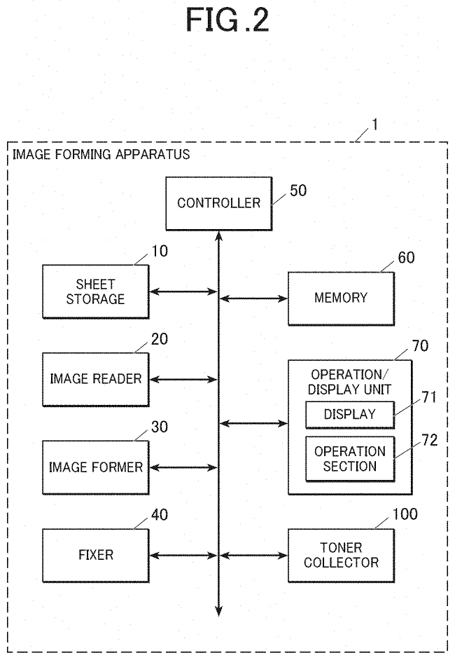

FIG. 1 is a schematic diagram illustrating an overall configuration of an image forming apparatus 1 according to the first embodiment. FIG. 2 is a block diagram illustrating a functional configuration of the image forming apparatus 1.

The image forming apparatus 1, which is intended to form an image on a sheet by means of electrophotography, is a tandem color image forming apparatus in which toners of four colors, yellow (Y), magenta (M), cyan (C) and black (K), are superimposed on one another.

The image forming apparatus 1 includes a substantial rectangular parallelepiped apparatus body 1A forming an outer covering, and in the apparatus body 1A, a sheet storage 10, an image reader 20, an image former 30, a fixer 40, a controller 50, a memory 60, an operation/display unit 70 and a toner collector 100 are provided.

The sheet storage 10 is disposed in a lower part of the image forming apparatus 1 and includes a plurality of trays 11 depending on sheet sizes or types. A sheet is supplied from a tray 11, fed to a conveyer 12 and conveyed to the image former 30 and the fixer 40 by the conveyer 12.

The image reader 20 reads an image of a document conveyed by a non-illustrated document conveyer or a document placed on a document stage 21 and generates image data. Also, the image reader 20 subjects the image data generated by means of A/D conversion to processing such as shading correction, dithering and/or compression and stores the resulting image data in a RAM (illustration omitted) of the later-described controller 50.

Note that image data is not limited to data output from the image reader 20 and may be image data received from an external apparatus such as a personal computer or another image forming apparatus connected to the image forming apparatus 1.

The image former 30 forms an image on a sheet based on an image forming job.

The image former 30 includes four image forming units 30Y, 30M, 30C, 30K for respective color components, Y, M, C and K, an intermediate transfer belt 33, a primary transferrer 34 and a secondary transfer roller 35.

Each of the image forming units 30Y, 30M, 30C, 30K includes, e.g., a drum-like photoconductor 31, a developer 32 arranged in the periphery of the photoconductor 31, and a charging electrode, a print head (exposer) and a cleaner, which are not illustrated.

The print head applies laser light onto the photoconductor 31, a surface of which has been charged by the charging electrode, for exposure and thereby forms an electrostatic latent image on the photoconductor 31.

The developer 32 supplies toner of a predetermined color (any of Y, M, C and K) onto the exposed photoconductor 31 via a development roller to develop the electrostatic latent image formed on the photoconductor 31.

Respective images (monochromatic images) formed on the four photoconductors 31 for Y, M, C and K by toners of Y, M, C and K are transferred from the respective photoconductors 31 to the intermediate transfer belt 33. The intermediate transfer belt 33 is an endless belt looped around a plurality of conveyance rollers and rotates according to rotations of the respective conveyance rollers.

Primary transferrers 34 are provided at respective positions at which the primary transferrers 34 face the respective photoconductors 31 of the image forming units 30Y, 30M, 30C, 30K on the inner circumferential side of the intermediate transfer belt 33. Each primary transferrer 34 applies a voltage of a polarity opposite to that of toner to the intermediate transfer belt 33 to transfer the toner adhering to the photoconductor 31 to the intermediate transfer belt 33.

Then, upon the intermediate transfer belt 33 being driven and rotated, the toner images formed by the four image forming units 30Y, 30M, 30C, 30K are sequentially transferred to a surface of the intermediate transfer belt 33. In other words, on the intermediate transfer belt 33, the respective toner images with Y, M, C and K as color components are superimposed on one another and thereby form a color image.

A secondary transfer roller 35 is disposed at a position at which the secondary transfer roller 35 faces an outer circumferential side of the intermediate transfer belt 33. A nip portion at which the secondary transfer roller 35 and the intermediate transfer belt 33 come into contact with each other is a transfer position, and the secondary transfer roller 35 brings a sheet conveyed by the conveyer 12 into contact with the intermediate transfer belt 33 to transfer the toner image formed on the outer circumferential surface of the intermediate transfer belt 33 to the sheet.

The fixer 40 is provided on the sheet output side of the secondary transfer roller 35.

The fixer 40 includes a pair of rollers including a heating roller and a pressing roller. The sheet is conveyed through a nip portion of the pair of rollers and thereby heated and pressed, whereby the toner image transferred on the sheet is melted and fixed.

Also, a suction duct 36 is disposed on the upper side of each of the developers 32 of the four image forming units 30Y, 30M, 30C, 30K. In other words, the four suction ducts 36 are provided for the four image forming unit 30Y, 30M, 30C, 30K. Air containing toner scattered in each of the image forming unit 30Y, 30M, 30C or 30K flows through the corresponding one of the suction ducts 36.

An air duct 80 is connected to each of the four suction ducts 36. The air duct 80 serves to guide air containing scattered toner (toner-containing air) from the four suction ducts 36 to the toner collector 100. The air duct 80 includes a first duct 81 on the upstream side in an air flow direction and a second duct 82 provided on the toner collector 100 side relative to the first duct 81. The first duct 81 guides toner-containing air downward.

Four communication ports to which the respective suction ducts 36 are connectable are provided in a side surface of the first duct 81, the side surface facing the four image forming units 30Y, 30M, 30C, 30K. On the other hand, four communication openings 83Y, 83M, 83C, 83K that are in communication with the second duct 82 are provided in a side surface, on the side opposite to the side facing the four mage forming units 30Y, 30M, 30C, 30K, of the first duct 81.

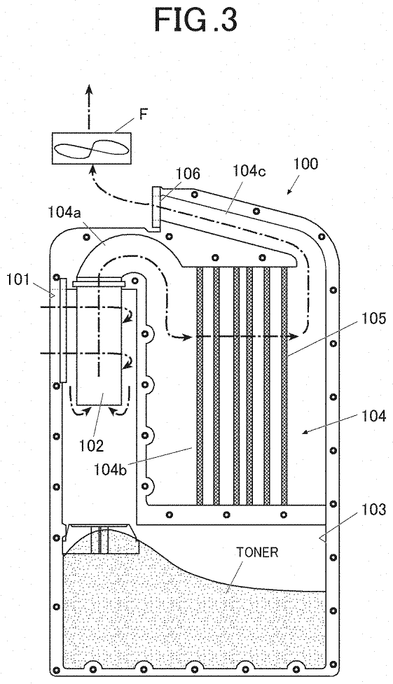

Also, a connection port 82a to which an inlet 101 (see FIG. 3) of the toner collector 100 is connected is provided on the side of the second duct 82, the side being opposite to the first duct 81.

Also, a fan F is disposed above the toner collector 100. The fan F generates a flow of air from the first duct 81 and the second duct 82 to exhaust the air to the outside of the image forming apparatus 1 through the inside of the toner collector 100. More specifically, air flowing into the inside of the toner collector 100 from the first duct 81 and the second duct 82 exits from an outlet 106 (see FIG. 3) and is subsequently discharged to the outside of the image forming apparatus 1 through the fan F.

The controller 50 includes, e.g., a CPU (Central Processing Unit) and a RAM (Random Access Memory). The CPU of the controller 50 reads various programs such as a system program and processing programs stored in the memory 60 and loads the programs in the RAM and execute various kinds of processing according to the loaded programs.

The memory 60 includes, e.g., an HDD (Hard Disk Drive) or a non-volatile semiconductor memory. In the memory 60, various programs to be executed by the controller 50, including the system program and the processing programs, and data necessary for execution of these programs are stored.

The operation/display unit 70 includes a display 71 that displays various pieces of information on a display screen and an operation section 72 to be used for input of various instructions by a user.

Next, the toner collector 100 will be described with reference to FIG. 3.

FIG. 3 is a diagram schematically illustrating the toner collector 100. Note that in FIG. 3, a flow of air is schematically indicated by an alternate long and short dash line.

As illustrated in FIG. 3, the toner collector 100 (cyclone unit) has a substantial rectangular parallelepiped outer shape and is detachable from the second duct 82. Also, the toner collector 100 includes the inlet 101, a cyclone 102, a reservoir 103, an air flow passage 104, a filter 105 and an outlet 106.

The inlet 101 is a reception port that receives toner-containing air passed through from the first duct 81 and the second duct 82.

Upon the toner collector 100 being attached to the second duct 82, the inlet 101 faces the connection port 82a (see FIG. 1) of the second duct 82. Consequently, the cyclone 102 communicates with an inner space of the second duct 82 via the inlet 101.

The cyclone 102 centrifugally separates toner from toner-containing air flowing in via the inlet 101 after passing through the first duct 81 and the second duct 82. The cyclone 102 has a cylindrical shape and an axis direction of the cyclone 102 agrees with a top-bottom direction (direction in which gravity acts).

Toner-containing air that has flowed in the cyclone 102 flows in a direction of a tangent to an inner circumference of the cyclone 102. Consequently, a swirl flow in which air swirls occurs inside the cyclone 102.

Toner in the swirl flow moves radially by means of a centrifugal force, which is exerted as a result of an object making circular motion, and thus, a majority of the toner is separated (centrifugally) from the air. The separated toner falls down under its own weight and stored in the reservoir 103. On the other hand, the air flows into the inside of the cyclone 102 from the lower end side of the cylindrical part of the cyclone 102 and enters an inflow portion 104a of the air flow passage 104, the inflow portion 104a being provided on the upper side of the cyclone 102.

The air flow passage 104 includes the inflow portion 104a that communicates with the cyclone 102, a filter disposition portion 104b that communicates with the inflow portion 104a and an outflow portion 104c that communicates with the filter disposition portion 104b.

The inflow portion 104a has a U-shaped pipe form and vertically inverts air flowing in from the cyclone 102 and guides the air to the filter disposition portion 104b.

A filter 105 that filters out toner is disposed in the filter disposition portion 104b.

The filter 105 is intended to collect a small amount of toner contained in the air passed through the cyclone 102, and consequently, the air passed through the filter 105 is purified.

For the filter 105, arranging a plurality of filters in layers in a direction in which air passes increases the effect of air purification and thus is preferable. For example, in the filter 105, e.g., a toner dust prevention filter and an ozone catalyst filter are arranged in a predetermined layout.

The air passed through the filter 105 of the filter disposition portion 104b flows into the outflow portion 104c provided on the upper side of the filter disposition portion 104b and then flows out to the fan F side from the outlet 106 formed on the downstream side in the air flow direction (side opposite to the cyclone 102) of the outflow portion 104c.

As described above, air drawn in from the respective suction ducts 36 passes through the first duct 81, the second duct 82, the inlet 101, the cyclone 102, the inflow portion 104a, the filter disposition portion 104b (filter 105), the outflow portion 104c and the outlet 106 and subsequently also passes through the fan F and is discharged to the outside of the image forming apparatus 1.

In the toner collector 100, the cyclone 102, the reservoir 103 and the filter 105 are integrated, and for example, if the reservoir 103 is full with toner, the cyclone 102, the reservoir 103 and the filter 105 can be replaced integrally.

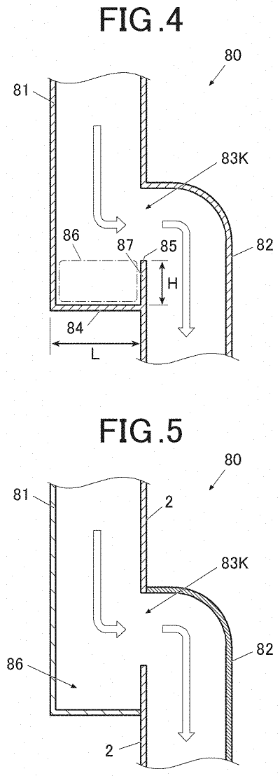

FIG. 4 is a sectional view schematically illustrating an area around a communication opening 83K of the air duct 80. In reality, the second duct 82 is connected also to a part above the communication opening 83K, and illustration of the part is omitted in FIG. 4. The same applies to the subsequent drawings. A bottom surface 84 of the first duct 81 is provided on the lower side relative to a lower end 85 of the communication opening 83K for communication between the first duct 81 and the second duct 82, thereby forming a reservoir 86 that stores toner.

Also, a wall 87 extending from the lower end 85 of the communication opening 83K to the bottom surface 84 of the first duct 81 is provided on the second duct 82 side of the first duct 81. A height H of the wall 87 is desirably no less than ⅕ of a length L of the bottom surface 84 of the first duct 81. Here, the length L of the bottom surface 84 is a length in a direction orthogonal to a plane that is a boundary between the first duct 81 and the second duct 82 and corresponds to a distance from a position closest to the second duct 82 to a position farthest from the second duct 82 in the first duct 81.

Conventionally, an air duct provided upstream of a toner collector 100 is formed so as to have a route that makes a flow of air smooth; however, in the present invention, the reservoir 86 that serves as a resistance to a flow of air at a position partway of a route of the air duct 80 to reduce an amount of toner fed to the toner collector 100.

Also, the first duct 81 and the second duct 82 are formed separately from each other. A reservoir 86 is disposed on the first duct 81 side of a connection portion at which the first duct 81 and the second duct 82 are connected (communication opening 83K).

More specifically, as illustrated in FIG. 5, each of the first duct 81 and the second duct 82 is connected to a body panel 2 included in the image forming apparatus 1 and the reservoir 86 is thereby formed at the connection portion between the first duct 81 and the second duct 82. Note that in FIG. 5, in order to distinguish among the body panel 2, the first duct 81 and the second duct 82, respective sectional surfaces thereof are indicated by different patterns.

As described above, according to the first embodiment, providing the bottom surface 84 of the first duct 81 on the lower side relative to the lower end 85 of the communication opening 83K for communication between the first duct 81 and the second duct 82 allows a part of air flowing from the first duct 81 to the second duct 82 to cause turbulence below the communication opening 83K of the first duct 81 and thus enables storing of toner in the air in the reservoir 86. Toner is stored at a site that is different from the reservoir 103 of the toner collector 100 (cyclone unit) and an amount of toner reaching the filter 105 is thereby reduced, enabling reducing a frequency of replacement of the filter 105 without cost increase due to, e.g., increasing a volume of air from the fan F. As described above, the CPP can be enhanced by decreasing the frequency of replacement of the filter 105 (or the toner collector 100) and thereby reducing the number of filters used.

Also, as a result of the wall 87 being provided on the lower side relative to the lower end 85 of the communication opening 83K on the second duct 82 side of the first duct 81, that is, the lower side of a part in which an air flow curves from the flows first duct 81 to the second duct 82, turbulence easily occurs in air entered in the reservoir 86.

Also, since the first duct 81 and the second duct 82 are each molded as molded components, they are normally formed separately from each other. In other words, the air duct 80 includes a plurality of components, but the reservoir 86 can easily be formed using the connection portion between the first duct 81 and the second duct 82.

### Second Embodiment

Next, a second embodiment to which the present invention is applied will be described.

In an image forming apparatus according to the second embodiment, for components that are similar to those of the image forming apparatus 1 indicated in the first embodiment, reference numerals that are the same as those of the image forming apparatus 1 indicated in the first embodiment are used and illustration and description thereof will be omitted. A configuration that is characteristic to the second embodiment will be described below.

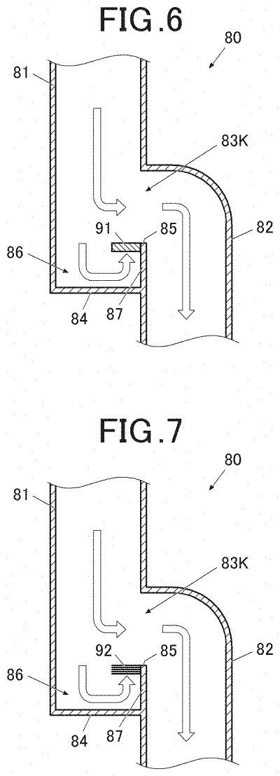

FIG. 6 is a sectional view schematically illustrating an area around a communication opening 83K of an air duct 80.

In a first duct 81, a projection 91 is provided so as to close a part of a reservoir 86. The projection 91 is a plate-like member with a lower end 85 of a communication opening 83K as an end thereof, the member being substantially parallel to a bottom surface 84 of the first duct 81. The projection 91 is formed so as to cover a part of the reservoir 86 in a range of area that is equal to or exceeds a predetermined area.

According to the second embodiment, provision of the projection 91 induces adherence of toner in air to a wall 87 or a lower surface of the projection 91 by turbulence occurred in the reservoir 86 and enables preventing toner from returning from the reservoir 86 to the upper side relative to the lower end 85 of the communication opening 83K.

### Third Embodiment

Next, a third embodiment to which the present invention is applied will be described.

In an image forming apparatus according to the third embodiment, for components that are similar to those of the image forming apparatus 1 indicated in the first embodiment, reference numerals that are the same as those of the image forming apparatus 1 indicated in the first embodiment are used and illustration and description thereof will be omitted. A configuration that is characteristic to the third embodiment will be described below.

FIG. 7 is a sectional view schematically illustrating an area around a communication opening 83K of an air duct 80.

In a first duct 81, a moquette 92 is provided so as to close a part of a reservoir 86. The moquette 92 is formed of raised woven fabric and may include a plurality of fabrics put together. The moquette 92 is arranged substantially in parallel with a bottom surface 84 of the first duct 81, with a lower end 85 of a communication opening 83K as an end thereof. The moquette 92 is formed so as to cover a part of the reservoir 86 in a range of area that is equal to or exceeds a predetermined area.

According to the third embodiment, provision of the moquette 92 induces adherence of toner in air to a wall 87 or the moquette 92 by turbulence occurred in the reservoir 86 and enables preventing the toner from returning from the reservoir 86 to the upper side relative to the lower end 85 of the communication opening 83K.

### Fourth Embodiment

Next, a fourth embodiment to which the present invention is applied will be described.

In an image forming apparatus according to the fourth embodiment, for components that are similar to those of the image forming apparatus 1 indicated in the first embodiment, reference numerals that are the same as those of the image forming apparatus 1 indicated in the first embodiment are used and illustration and description thereof will be omitted. A configuration that is characteristic to the fourth embodiment will be described below.

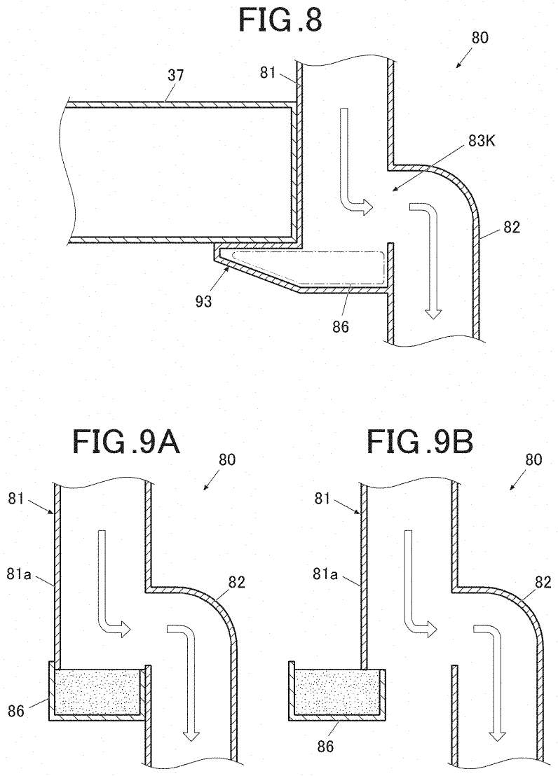

FIG. 8 is a sectional view schematically illustrating an area around a communication opening 83K of an air duct 80.

A first duct 81 includes a mounting base 93 for mounting of a print head 37 at a side surface on the side opposite to the second duct 82. The mounting base 93 protrudes to the outer side of the first duct 81 and a hollow is formed inside the mounting base 93. The inside of the mounting base 93 forms at least a part of a reservoir 86.

The print head 37 is a print head (exposer) of an image forming unit 30K located undermost from among image forming units 30Y, 30M, 30C, 30K. In order to form an image of black, the print head 37 applies laser light onto a photoconductor 31 of the image forming unit 30K. The print head 37 is fixed in a state in which the print head 37 is placed on the mounting base 93.

According to the fourth embodiment, since the inside of the mounting base 93 is used as the reservoir 86, a space generated by the mounting base 93 for the print head 37, the mounting base 93 being an essentially necessary component, can be effectively utilized. Also, provision of the hollow inside the mounting base 93 enables adherence of toner to an inner wall surface of the hollow by turbulence occurred in the reservoir 86.

Noe that although the first duct 81 includes respective mounting bases for mounting of print heads of the image forming units 30Y, 30M, 30C, the inside of each of the mounting bases does not form a part of the reservoir 86.

### Fifth Embodiment

Next, a fifth embodiment to which the present invention is applied will be described.

In an image forming apparatus according to the fifth embodiment, for components that are similar to those of the image forming apparatus 1 indicated in the first embodiment, reference numerals that are the same as those of the image forming apparatus 1 indicated in the first embodiment are used and illustration and description thereof will be omitted. A configuration that is characteristic to the fifth embodiment will be described below.

FIG. 9A is a sectional view schematically illustrating an area around a communication opening 83K of an air duct 80. A first duct 81 includes a reservoir 86 and a duct body 81a. The reservoir 86 has a pocket-like shape and is detachable from the duct body 81a. As illustrated in FIG. 9B, a serviceperson detaches the reservoir 86 from the duct body 81a and sets a new reservoir 86 in the duct body 81a.

The controller 50 acquires the number of times of a fan F that generates an air flow in order to discharge air passed through a filter 105 being turned off. For example, the controller 50 resets a count value of an off counter provided in a memory 60 to 0 when the reservoir 86 has been replaced with a new one. The controller 50 adds 1 to the value of the off counter each time the fan F is turned off. The controller 50 acquires the number of times of the fan F being turned off by reading the count value of the off counter from the memory 60.

Upon the fan F being turned off from an on state, a flow of air from the first duct 81 to a second duct 82 and a toner collector 100 is temporarily stopped and toner included in the air in the first duct 81 easily falls down to the reservoir 86. Therefore, the number of times of the fan F being turned off is an index for an amount of toner accumulated in the reservoir 86.

If the acquired number of times is equal to or exceeds a predetermined value, the controller 50 provides an instruction urging replacement of the reservoir 86. More specifically, if the acquired number of times is equal to or exceeds a predetermined value, the controller 50 causes a display 71 to indicate that a timing for replacement of the reservoir 86 has come. The predetermined value is set in advance to be a value that is suitable for detecting a timing for replacement of the reservoir 86.

According to the fifth embodiment, an instruction urging replacement of the reservoir 86 is provided based on the number of times of the fan F being turned off, and thus, a warning can be provided to a user when the reservoir 86 becomes unable to function.

### Sixth Embodiment

Next, a sixth embodiment to which the present invention is applied will be described.

In the image forming apparatus according to the sixth embodiment, for components that are similar to those of the image forming apparatus 1 indicated in the first embodiment, reference numerals that are the same as those of the image forming apparatus 1 indicated in the first embodiment are used and illustration and description thereof will be omitted. A configuration that is characteristic to the sixth embodiment will be described below.

In the sixth embodiment, as in the fifth embodiment, a reservoir 86 is detachable to a duct body 81a (see FIG. 9A and FIG. 9B).

A controller 50 detects a replacement timing for each of components other than the reservoir 86 in the image forming apparatus. For example, the controller 50 detects timings for replacement of, e.g., a toner collector 100 (cyclone unit), a filter 105 and charging electrodes of respective image forming units 30Y, 30M, 30C, 30K More specifically, the controller 50 resets a count value of a use counter for a subject component, the use counter being provided in a memory 60, to 0 when the subject component has been replaced with a new one. The controller 50 adds 1 to the value of the use counter each time the subject component is used. If the value of the use counter reaches an upper limit value set in advance, the controller 50 determines that a timing for replacement of the subject component has come. Note that a timing for replacement of the subject component may be detected by a sensor that detects a degree of contamination or current performance of the subject component.

The controller 50 provides an instruction urging replacement of the reservoir 86 at a timing that is the same as a detected timing for replacement of a component other than the reservoir 86. More specifically, the controller 50 causes a display 71 to indicate that a timing for replacement of the reservoir 86 has come, at a timing that is the same as the timing for replacement of the component other than the reservoir 86.

According to the sixth embodiment, an instruction urging replacement of the reservoir 86 can be provided at a timing that is the same as a timing for replacement of another component, enabling the reservoir 86 to be replaced at a timing that is the same as that of the other component and thus enabling reduction in number of times of a serviceperson coming.

Note that the reservoir 86 is designed to have a capacity that prevents the reservoir 86 from becoming full before the filter 105 reaches a service limit thereof. However, even if the reservoir 86 becomes full, air merely flows from a first duct 81 to a second duct 82 as it is, and thus, there is no problem even if the reservoir 86 is not replaced immediately.

Note that the description of each of the above embodiments indicates an example of an air duct and an image forming apparatus according to the present invention and is not intended to limit the present invention thereto. Details of the configuration and operation of each of respective units included in the apparatus can appropriately be changed without departing from the spirit of the present invention.

For example, configurations characteristics to the respective embodiments may be combined.

More specifically, the projection 91 in the second embodiment and the moquette 92 in the third embodiment may be combined by, e.g., attaching the moquette 92 to the projection 91.

Also, although each of the fifth embodiment and the sixth embodiment has been described in terms of the case where the reservoir 86 is detachable from the duct body 81a of the first duct 81 and the reservoir 86 is replaced with a new one, the reservoir 86 may be removed from the duct body 81a and set in the duct body 81a again after disposal of toner in the reservoir 86 and cleaning of the reservoir 86.

Although embodiments of the present invention have been described and illustrated in detail, the disclosed embodiments are made for purposes of illustration and example only and not limitation. The scope of the present invention should be interpreted by terms of the appended claims.

What is claimed is:

1. An air duct for guiding air containing scattered toner to a toner collector including a cyclone that centrifugally separates toner from the air containing scattered toner, and a filter that allows the air after the separation of the toner by the cyclone to pass through,
the air duct comprising a first duct that guides the air downward and a second duct that is provided on the toner collector side relative to the first duct and is in communication with a side surface of the first duct,
wherein a bottom surface of the first duct is provided on a lower side relative to a lower end of a communication opening for communication between the first duct and the second duct, thereby forming a reservoir that stores the toner.

2. The air duct according to claim 1, wherein a projection is provided so as to close a part of the reservoir.

3. The air duct according to claim 1, wherein a moquette is provided so as to close a part of the reservoir.

4. The air duct according to claim 1, wherein:
the first duct includes a mounting base for mounting of a print head, the mounting base protruding to an outer side of the first duct; and
an inner side of the mounting base forms at least a part of the reservoir.

5. The air duct according to claim 1, wherein:
the first duct and the second duct are formed separately from each other; and
the reservoir is arranged on the first duct side of a connection portion at which the first duct and the second duct are connected.

6. The air duct according to claim 1, wherein a wall extending from the lower end of the communication opening to the bottom surface of the first duct is provided on the second duct side of the first duct.

7. The air duct according to claim 1, wherein:
the first duct includes the reservoir and a duct body; and
the reservoir is detachable from the duct body.

8. An image forming apparatus comprising:
the air duct according to claim 7;
an image former;
the toner collector; and
a hardware processor that acquires a number of times of a fan that generates an air flow to discharge air passed through the filter being turned off, and if the acquired number of times is equal to or exceeds a predetermined value, provides an instruction urging replacement of the reservoir.

9. An image forming apparatus comprising:
the air duct according to claim 7;
an image former;
the toner collector; and
a hardware processor that detects a timing for replacement of a component other than the reservoir, and provides an instruction urging replacement of the reservoir, at a timing that is the same as the timing of replacement of the component other than the reservoir.
